(19) United States
(12) Patent Application Publication
(10) Pub. No.: US 2008/0062637 A1
(43) Pub. Date: Mar. 13, 2008

(54) Hard Disk Heat Dissipating Structure

(76) Inventor: Tien-Lu Chang, Taoyuan City (TW)

Correspondence Address: HDSL, 4331 STEVENS BATTLE LANE, FAIRFAX, VA, 22033, US

(21) Appl. No.: 11/530,884

(22) Filed: Sep. 11, 2006

(51) Int. Cl. G06F 1/20

(52) U.S. Cl. 361/687

(57) ABSTRACT

A hard disk heat dissipating structure adopts a computer casing as its main body, and the computer casing has a containing groove at the bottom of the front end of the computer casing for containing a box body. The box body is provided for containing a plurality of hard disks and has a connecting unit at its bottom, and the connecting unit has a plurality of parallel connecting interfaces for electrically coupling and fixing the hard disks. After the hard disks are inserted into the connecting interfaces, the hard disks are parallel to each other and an interval is formed between any two hard disks to define a substantial heat dissipating passage, such that the air entering into the computer casing by natural convection carries away the operating heat produced by the hard disks to enhance the heat dissipating efficiency of the hard disks.

### BACKGROUND OF THE INVENTION

1. Field of the Invention

The present invention relates to a heat dissipating structure, and more particularly to a hard disk heat dissipating structure for dissipating the heat of a hard disk.

2. Description of Prior Art

As high technologies are blooming, and the semiconductor fabricating process and electronic packaging technology advance, electronic components tend to be developed in a high density, a high capacity and a small volume, so as to avoid a large quantity of heat produced by the operations of electronic components. To allow electronic components generating a great deal of operating heat to operate at a normal working temperature while avoiding the large quantity of heat produced by the electronic components from reducing the life expectancy and stability of the electronic components, an appropriate heat dissipation solution becomes an important issue.

Particularly in a computer system, different kinds of electronic components such as a motherboard, a power supply and a hard disk are installed in the same casing of the computer system, and these components will generate a large quantity of heat during their operations, and thus a common measure taken by the prior art is to install a fan at the position of a heat generating component. The rotation of vanes of the fan drives the air around the electronic components to flow faster and carry way the heat of the electronic components, so as to achieve the effect of dissipating heat.

Although a fan is a simple and fast heat dissipating device for the interior of a computer casing, the heat dissipation provided by a fan generally has the effect on a specific electronic component, but it has no substantial heat dissipating effect on other electronic components such as a hard disk without installing a fan. Since the present computer systems make the expansion of their computer very convenient to users and fulfill users' high demand on hard disks, therefore it is very common to have several hard disks in a computer system.

To enhance the expandability of a computer and the installation of additional hard disks in a limited space of the computer system, the hard disks are installed parallel to each other along a vertical direction or a horizontal direction, and each hard disk has a connecting interface board disposed at the rear end of the hard disk to facilitate the installation and removal of the hard disk. Although such structural design can be used effectively in the limited space, it also creates a heat dissipation issue for the operating heat produced during the operations of the hard disks.

The space inside a computer system is very limited, and thus it is not easy to install additional fans or other heat dissipating structures in the computer system, and the natural convection of the computer system becomes very important. However, the connecting interface at the rear end of the hard disk blocks the airflow and makes the areas for containing the hard disks a closed environment, and the operating heat generated by the hard disks cannot be discharged to the outside simply by natural convection, and the rising temperature in the closed environment will affect the stability and life expectancy of the hard disks. Therefore, such heat dissipation issue of the hard disks demands immediate attentions and feasible solutions.

### SUMMARY OF THE INVENTION

In view of the foregoing shortcomings of the prior art, the inventor of the present invention based on years of experience in the related industry to conduct experiments and modifications, and finally designed a hard disk heat dissipating structure in accordance with the present invention.

Therefore, the present invention is to provide a hard disk heat dissipating structure with a heat dissipating passages, such that a connecting unit of a hard disk is installed at the bottom of a box body, and an interval is formed between any two hard disks to allow air to enter into the surrounding of the hard disks by natural convection and define a substantial heat dissipating passage. In the meantime, the operating heat generated by the hard disks can be carried away to enhance the heat dissipating effect for the hard disks.

The present invention provides a hard disk heat dissipating structure, which uses a computer casing as its main body, and the computer casing has a containing groove disposed at the bottom of a front end of the computer casing for containing a box body, and the box body is provided for containing a plurality of hard disks. The box body has a connecting unit disposed at its bottom, and the connecting unit has a plurality of parallel connecting interfaces for electrically connecting and fixing the positions of the hard disks. By then, the plurality of hard disks are inserted into the connecting interfaces and then the plurality of hard disks are arranged parallel to each other, such that an interval is formed between any two hard disks to define a substantial heat dissipating passage. With the natural convection, the air entering into the computer casing can carry away the operating heat generated by the hard disks.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a schematic view of the front side of the structure of the present invention;

FIG. 2 is a schematic view of the rear side of the structure of the present invention;

FIG. 3 is a schematic view of the operation of the present invention;

FIG. 4 is another schematic view of the operation of the present invention; and

FIG. 5 is a schematic view of the airflow of the present invention.

### DETAILED DESCRIPTION OF THE INVENTION

The technical characteristics, features and advantages of the present invention will become apparent in the following detailed description of the preferred embodiments with reference to the accompanying drawings. However, the drawings are provided for reference and illustration only and are not intended for limiting the scope of the invention.

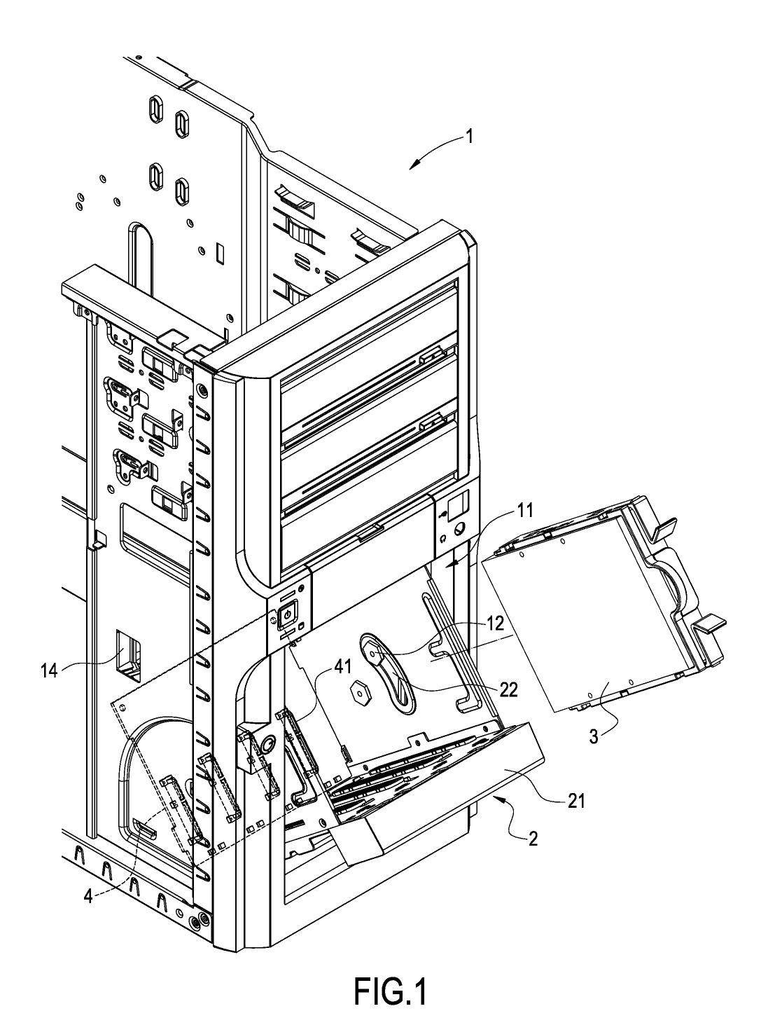

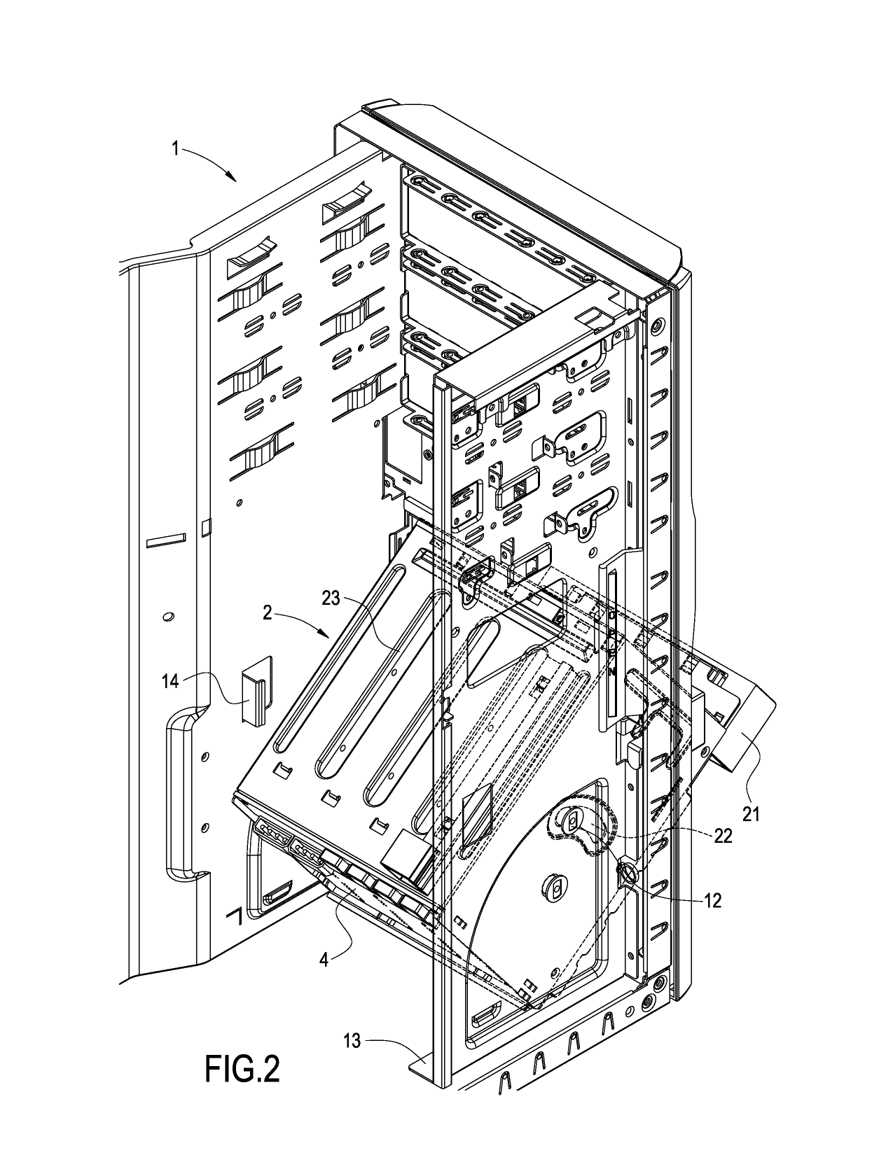

Referring to FIGS. 1 and 2 for schematic views of the front and rear sides of the structure of the present invention respectively, a hard disk installing structure uses a computer casing 1 as its main body, and the computer casing 1 comprises a containing groove 11 disposed at the bottom of the front of the computer casing 1 and enclosed by the chassis of the computer casing 1, a fixing rod disposed separately on both sides of the chassis of the containing groove 11, a slide 13 (as shown in FIG. 2) disposed separately on both sides of the bottom of the containing groove 11, and a fixing base 14 disposed separately on both sides of the rear end of the containing groove 11. The computer casing 1 has a box body 2 for containing one or more storage units 3, and the storage unit in this embodiment is a hard disk, wherein the box body 2 is contained in the containing groove 11 of the computer casing 1. The box body 2 has a handle 21 disposed at its front end and provided for users to pull the box body 2. Further, the box body 2 has an arc sliding groove 22 disposed separately on both side panels of the box body 2, and the sliding groove 22 is disposed at a fixing rod 12 on the containing groove 11, and both sides of the bottom of the box body 2 are disposed across the slide 13, such that the box body 2 can be moved back and forth. Further, the box body has a plurality of parallel slots 23 disposed at its back and a connecting unit 4 disposed at the bottom of the box body 2, and the interface 4 has a plurality of parallel connecting interfaces 41 for electrically connecting and fixing the storage units 3.

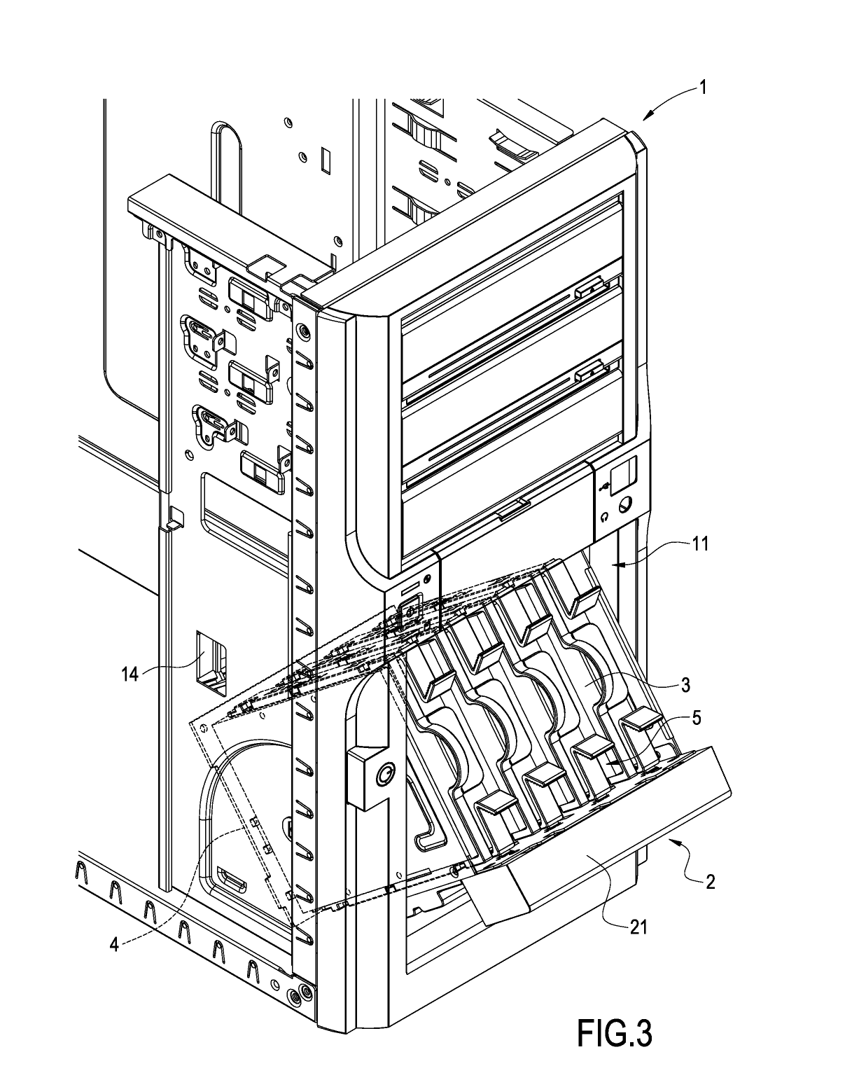

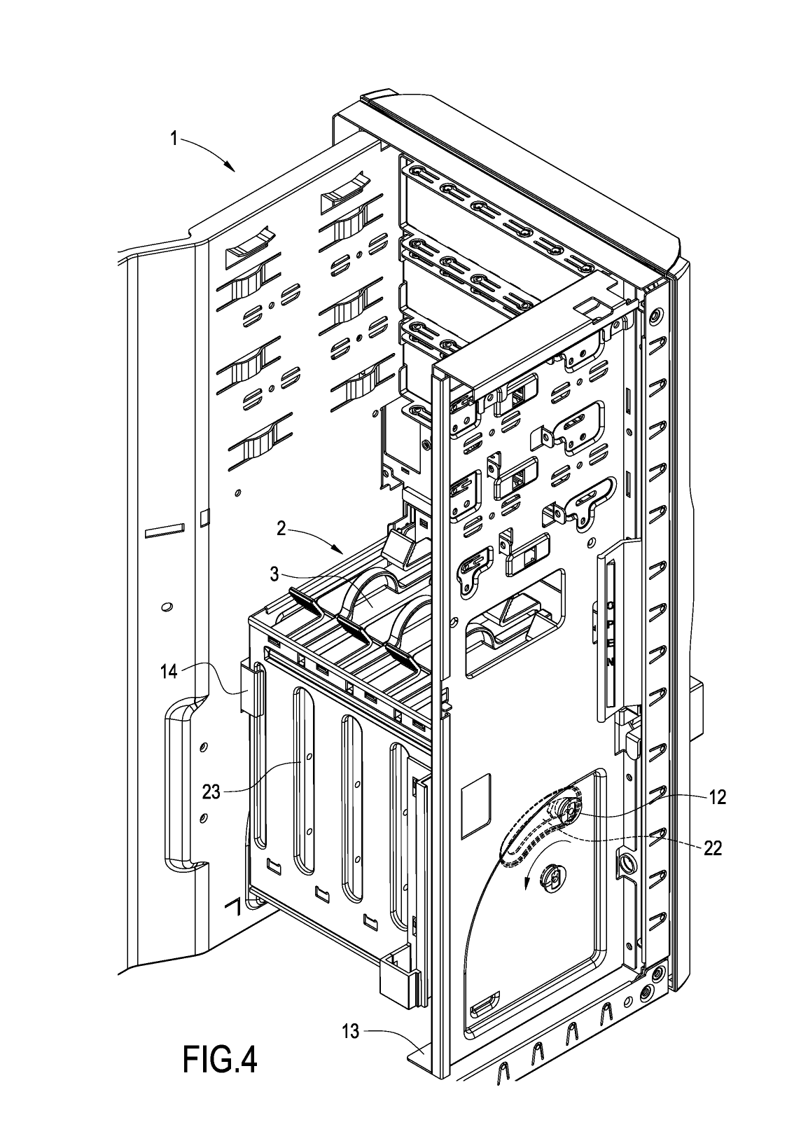

Referring to FIGS. 3 and 4 for schematic views of the operations of the present invention, a user can hold the handle 21 to pull the box body 2 if the user wants to add or replace a storage unit 3 in the computer system. By then, the box body 2 is driven by the sliding groove 22 on both sides and the bottom of the box body 2 is slid along the slide 14, so that the box body 2 will be tilted accordingly when the user pulls the box body 2 as shown in FIG. 4, and the opening of the box body 2 faces upward to facilitate the user to connect the storage unit 3 by the connecting interface 41 through the connecting unit 4 at the bottom of the box body 2 and electrically connect the electronic components in the computer casing 1 (since all these belongs to a prior art and thus will not be described here). In the meantime, the plurality of storage units 3 are inserted separately into each connecting interface 41, and an interval 5 is formed between any two storage units, and the interval 5 is corresponsive to the slot 23 on the box body 2. After a user completes the installation of the storage units 3, the user can hold the handle 21 to push the box body 2 back to its original position in the containing groove 11 of the computer casing 1. The box body 2 is driven by the sliding groove 22 to press at the fixing base 14 at the rear end of the containing groove 11, so as to fix the box body 2 into its position.

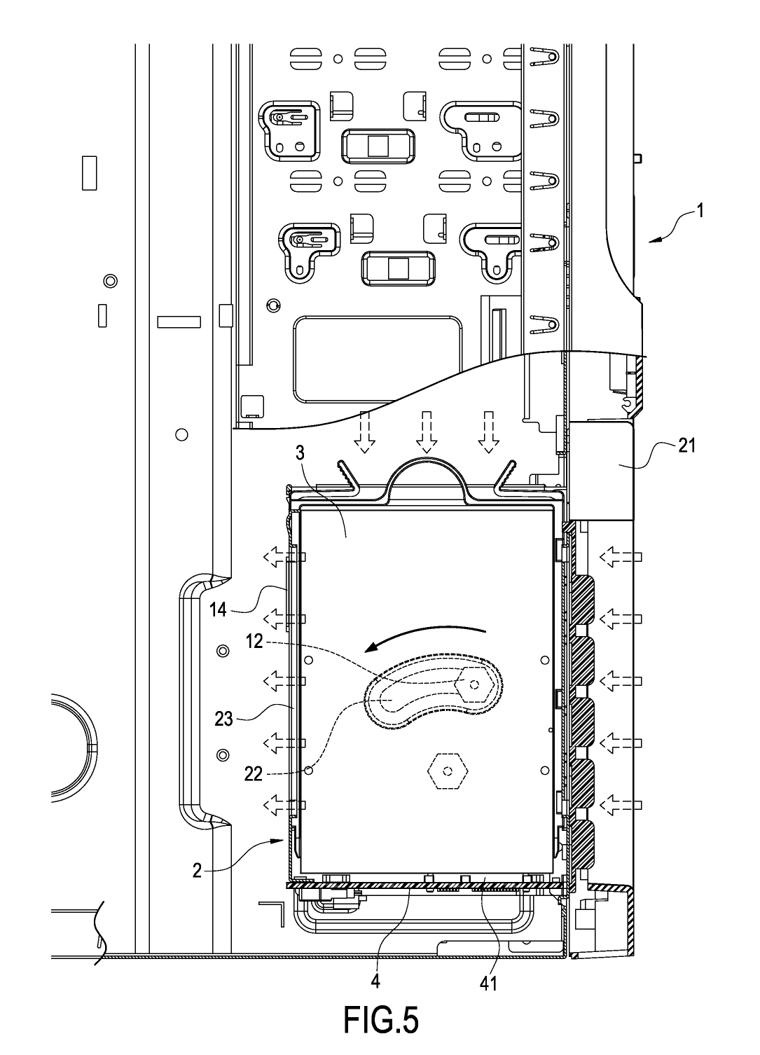

Referring to FIG. 5, the air enters into the interval 5 in the box body 2 by natural convection, so that the heat produced by the operations of the storage unit 3 in the box body 2 and the air produce hot air after a heat exchange, and the hot air flows upward from each interval 5 or backward from the slot 23 and is discharged out of the box body 2 by the natural convection (wherein the arrowed direction indicates the direction of the airflow), and the heat is carried away from the surrounding of the storage unit 3, and the external cold air enters from the interval 5 to the surrounding of the storage unit 3 to form a circular process, and the interval 5 defines a heat dissipating passage to enhance the heat dissipating efficiency of the storage unit 3.

The present invention is illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

1. A hard disk heat dissipating structure, that provides a heat dissipating function for a hard disk, comprising:
a computer casing, having a containing groove formed at front of the computer casing a fixing rod disposed on each sidewall of the containing groove a side disposed on each side of bottom of the containing groove and a fixing base disposed on each side of rear upper end of the containing groove;
a box body, contained in the containing groove of the computer casing, having a handle disposed at front of the box body an arc sliding groove disposed on each side panel of the box body to be engaged with the fixing rod and a plurality of slots disposed at a front and a rear panels of the box body a connecting unit being disposed at bottom of the box body, and the connecting unit having a plurality of connecting interfaces for electrically coupling a plurality of hard disks and both sides of the bottom of the box body being disposed on the slides so that the box body can be moved back and forth in the containing groove from the front of the computer casing for receiving the hard disks from top of the box body,
such that after the hard disks are connected sequentially with the connecting interfaces, an interval is formed between any two hard disks to be corresponsive with each slot, and after hot air is formed by operating heat generated from the hard disk, the hot air will flow through the interval to the slot outside, and then external cold air enters into the box body to constitute a natural convection.

2. (canceled)
